(19) United States
(12) Patent Application Publication
(10) Pub. No.: US 2024/0409143 A1
(43) Pub. Date: Dec. 12, 2024

(54) The Dolly Tool

(71) Applicant: Troy Turner, Wichita, KS (US)

(72) Inventor: Troy Turner, Wichita, KS (US)

(21) Appl. No.: 18/809,235

(22) Filed: Aug. 19, 2024

(51) Int. Cl. B62B 5/06

(52) U.S. Cl. CPC B62B 5/06

(57) ABSTRACT

The Dolly Tool is an innovative device, designed to aid a secondary user in lifting and maneuvering heavy loads on a dolly. It includes a robust support frame, ergonomically positioned lifting handles and a unique hook edge. The Dolly Tool is a lifting assist tool that represents a significant advancement in material handling technology, addressing the common challenges associated with lifting and maneuvering heavy loads. By providing additional leverage and support through an ergonomic and easily attachable design, this tool not only enhances the efficiency and safety of material handling operations in addition to the reduction of physical strain on users. It's compatibility with various dolly designs and ease of installation make it a versatile solution for a wide range of applications. The Dolly Tool is poised to become an important accessory for improving productivity and safety in environments where heavy lifting is a routine task.

### CROSS REFERENCED TO RELATED APPLICATION

This application claims the benefit of U.S. Provisional Application No. 63/675,260 filed on Jul. 25, 2024, the disclosure of

### FIELD OF THE INVENTION

This invention relates to a t-shaped tool. The innovative t-shaped design of this tool creates a comfortable, structurally sound, and easy to use dual handle located at the top of the device, a long straight and sleek body, and a hook and latch edge located at the bottom. The unique hook edge found at the bottom of The Dolly Tool is used to attach the device onto the dolly in a secure and convenient manner. Once the device has been attached to the dolly, the user of The Dolly Tool can help assist the driver of the dolly, by using The Dolly Tool to lift the moving dolly.

### BACKGROUND OF THE INVENTION

Traditional dollies are commonly used to transport heavy objects. However, users often struggle with lifting objects onto the dolly and with transporting bulky or heavy objects on said dolly up and down stairwells, sharp inclines/declines, and over various rough terrain. In addition to the aforementioned hassles, many users will also have difficulty with lifting a loaded dolly in and out of moving trucks, homes, warehouses, and the entrances of various buildings. The present struggle associated with moving bulky or heavy objects on a dolly, presents a need for a tool that can assist in lifting a loaded dolly, to improve efficiency, reduce damage to items moved on the dolly, and help prevent the risk of injury from falling objects.

### SUMMARY

The present invention relates to a device that assists in lifting and transporting heavy objects residing on a dolly, using the device in connection with the bottom half of the dolly. The innovative design facilities the lifting of the loaded dolly with minimal effort and less risk of injury.

### BRIEF DESCRIPTION OF THE DRAWINGS

A comprehensive description of the prescribed embodiment of The Dolly Tool will be provided hereafter by the way of example, with reference to the accompanying figures in the drawings:

FIG. 1 illustrates a frontal view of The Dolly Tool. This view provides a detailed depiction of the t-shaped structure of the device starting with proportional handles connected by a horizontal center beam separating the right and left handles with an equal distance apart in length, followed by two connection points on the center beam to two support beams creating the body of the device, proceeding to the base of the device which is comprised of a rear horizontal support beam fused or welded or welded to the two main vertical support beams, leading to two base brackets at the base of the device with each respective bracket fused or welded to the individual main beams of the device with the front face of said brackets visible.

FIG. 2 illustrates a rear aerial view of The Dolly Tool. Starting from the top of the device accurately depicting the right and left handles, the horizontal center beam connecting the right and left handles an equal distance apart, the connection points to each of the two vertical center support beams creating the body of the device, proceeding to the base of the device which is comprised of a rear horizontal support beam fused or welded to the two main vertical support beams further fused or welded to two respective brackets.

FIG. 3 illustrates a front facing aerial view of The Dolly Tool. Starting from the top of the device depicting the right and left handles, the horizontal center beam connecting the right and left handles an equal distance apart, the connection points to each of the two vertical center support beams creating the body of the device, proceeding to the base of the device which is comprised of a rear horizontal support beam fused or welded to the two main vertical support beams further fused or welded to two respective brackets at the bottom of the vertical beams with each respective bracket forming a deep groove that is used to attach the base of The Dolly Tool to the dolly.

FIG. 4 illustrates a left side view of a front facing aerial view of The Dolly Tool. Starting from the top of the device accurately rendering the right and left handles, the horizontal center beam connecting the right and left handles an equal distance apart, the connection points to each of the two vertical center support beams creating the body of the device, proceeding to the base of the device which is comprised of a rear horizontal support beam fused or welded to the two main vertical support beams further fused or welded to two respective brackets with each respective bracket fused or welded to the individual main beams of the device forming a deep groove that is used to attach the base of The Dolly Tool to the dolly.

FIG. 5 illustrates a side view of the base of The Dolly Tool with prominent focus on the frontal view of the base, starting at the two vertical support beams that comprise the body of the device, leading to a rear horizontal support beam fused or welded to the two main vertical support beams near the base of the device, further fused or welded to two respective brackets with each respective bracket fused or welded to the individual main beams of the device forming a deep groove which serves as the connection point to latch The Dolly Tool onto a dolly device.

FIG. 6 illustrates an aerial frontal view of the base of The Dolly Tool with prominent focus on the base, starting at the two vertical support beams that comprise the body of the device, leading to a rear horizontal support beam fused or welded to the two main vertical support beams near the base of the device, further fused or welded to two respective brackets with each respective bracket fused or welded to the individual main beams of the device forming.

FIG. 7 illustrates an aerial view of The Dolly Tool, showcasing the t-shaped design of The Dolly Tool, depicting the left and right handles and the connection point between the straight dense body of the device comprised of two vertical support beams, and ending with two respective brackets at the base.

FIG. 8 illustrates a northeast front side view of The Dolly Tool securely attached to the dolly. This illustration highlights the mechanics of how The Dolly Tool is attached to the dolly. A front view of the two respective brackets connected to the two vertical support beams is located at the base clearly depicting how The Dolly Tool is attaches to the bottom of a dolly device.

FIG. 9 illustrates a left side ground-level view of The Dolly Tool firmly attached to the dolly with a focus on the mechanics of the attachment.

FIG. 10 illustrates an angled front view of The Dolly Tool connected to the dolly and highlights the mechanics of how The Dolly Tool is attached to the dolly, which provides a clear frontal view of the molded groove located at the base clearly depicting how The Dolly Tool attaches to the bottom of a dolly device.

### DETAILED DESCRIPTION OF THE INVENTION

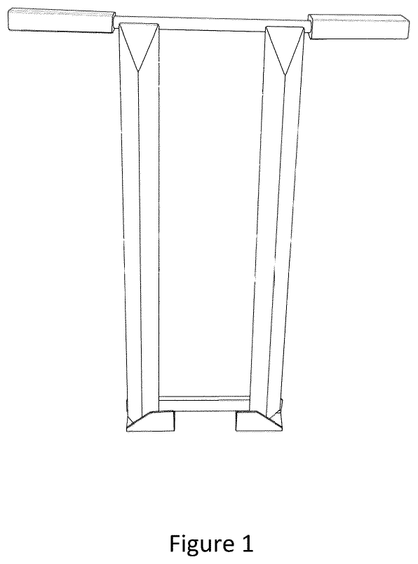

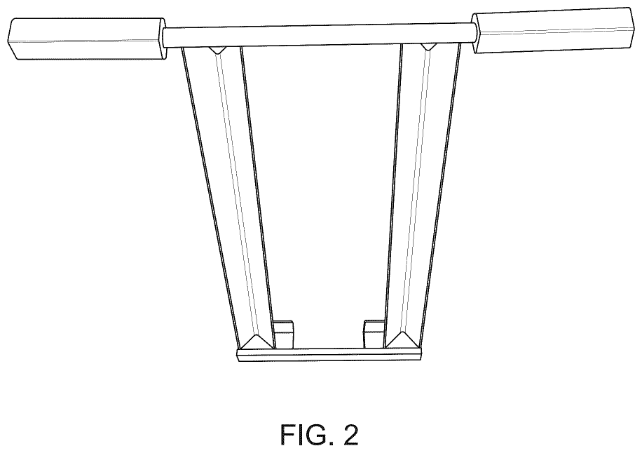

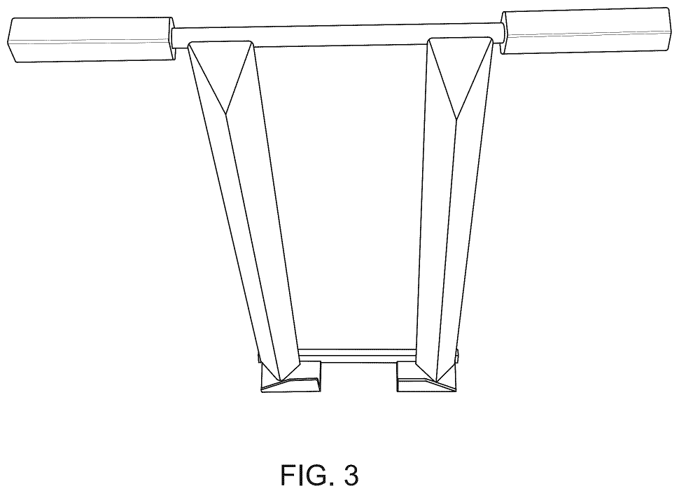

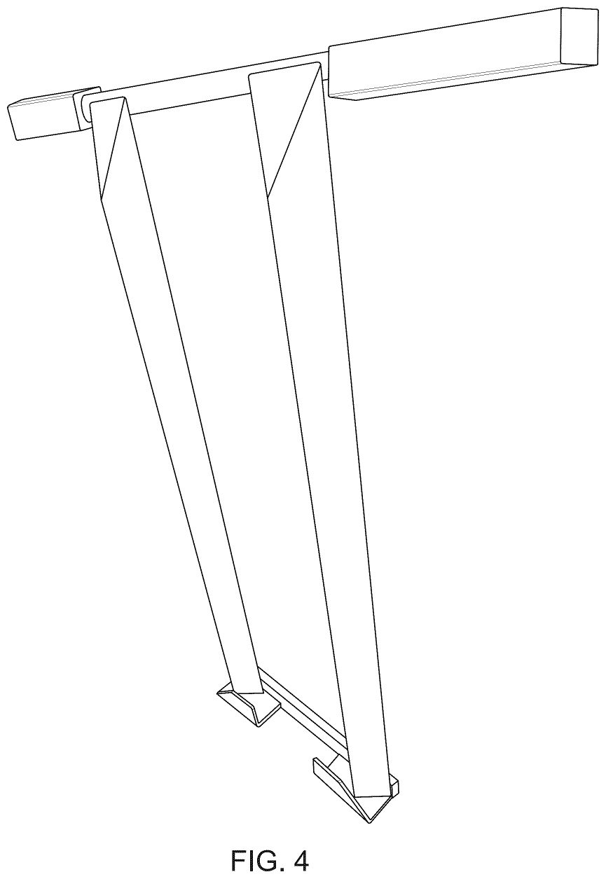

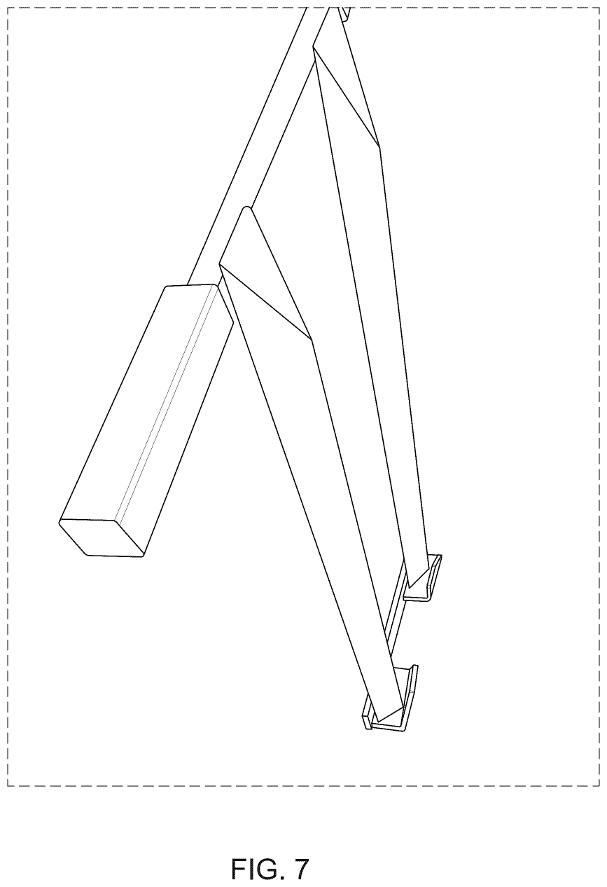

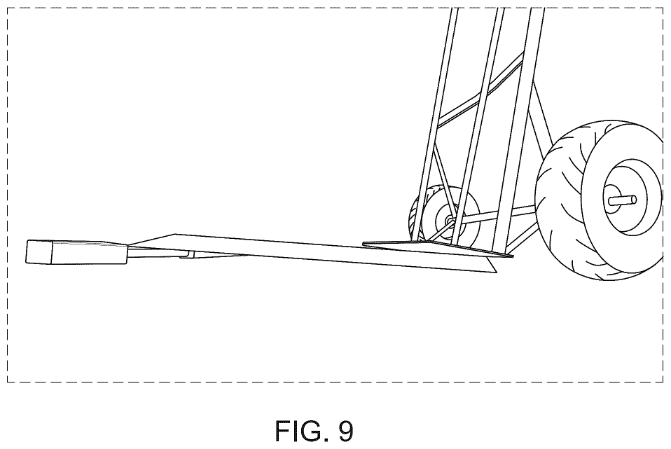

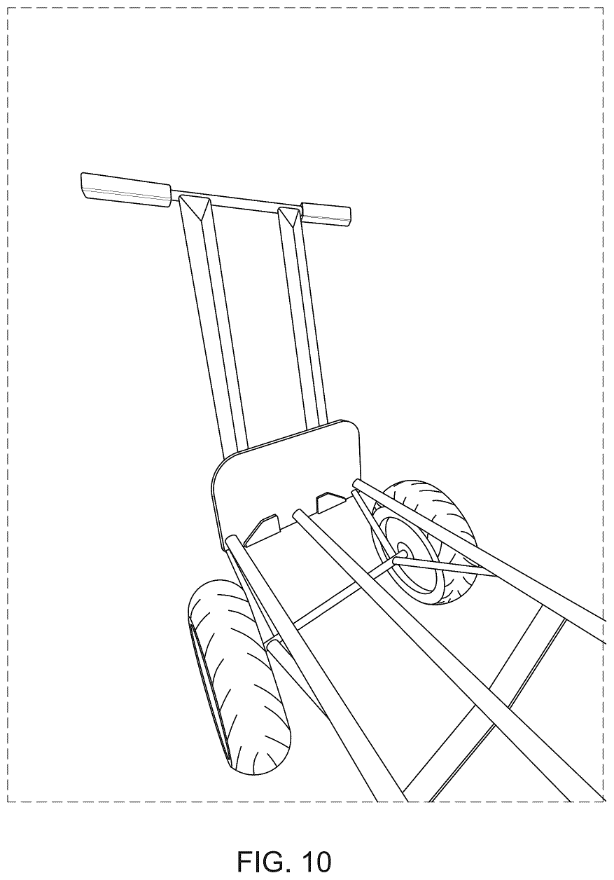

FIGS. 1 through 10, illustrates the The Dolly Tool as a sturdy, welded T-shaped device. The top of the device features a structurally sound symmetrical left and right handles, which defines its T-shape. This is followed by a long, straight and slender, dense body, that ends with a molded edge that ends at the base. The molded edge forms a deep groove designed to attach The Dolly Tool securely to the bottom of the dolly.

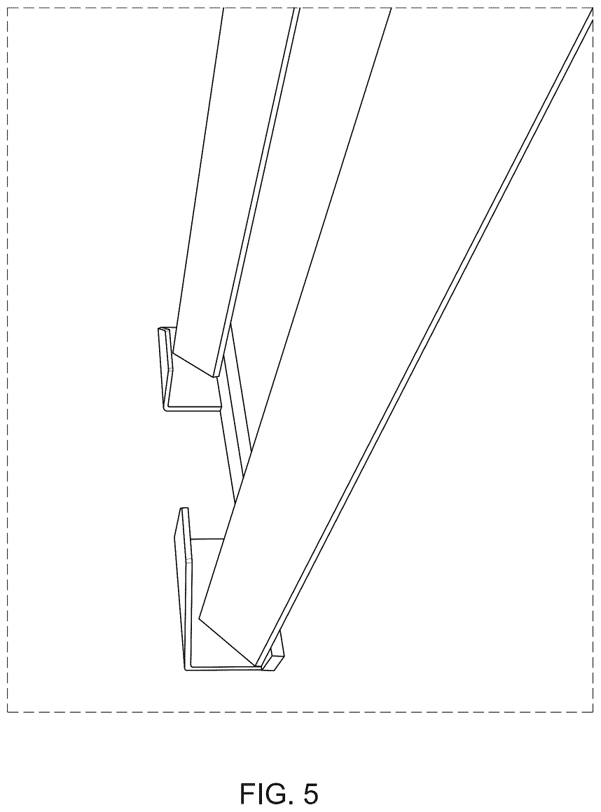

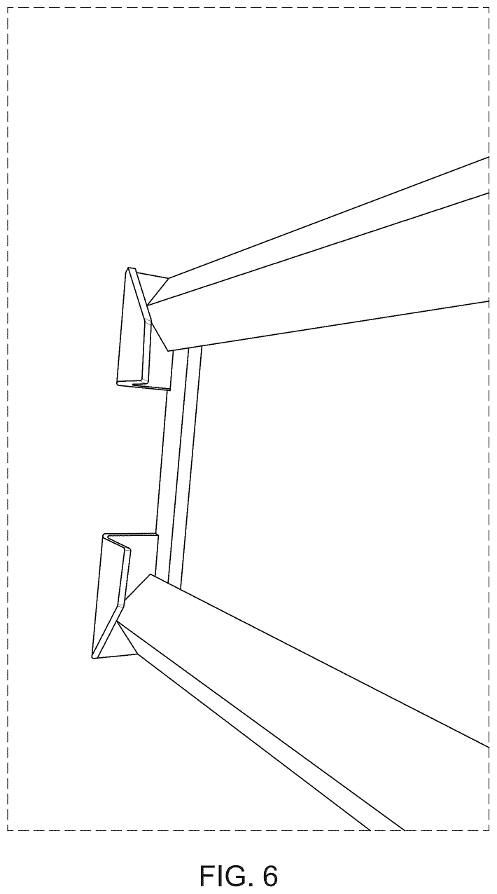

As shown in FIG. 5 and FIG. 6, The Dolly Tool features two vertical support beams that form the body of the device. These beams connect to the rear horizontal support beam near the base, which is fused or welded to the vertical beams. The structure is further reinforced by two brackets each attached to the individual main beams, creating a deep groove that serves as the connection point for securing The Dolly Tool to a dolly.

Illustrated in FIG. 1 through FIG. 4 and FIG. 7, the top of the device clearly, the right and left handles, joined by a horizontal center beam. This beam connects the handles, evenly spaced from the attachment points of the two vertical center support beams that form the main structure of the device. The body extends downward to the base, which includes a rear horizontal support beam that is fused or welded to the primary vertical support beams and securely attached to two respective brackets.

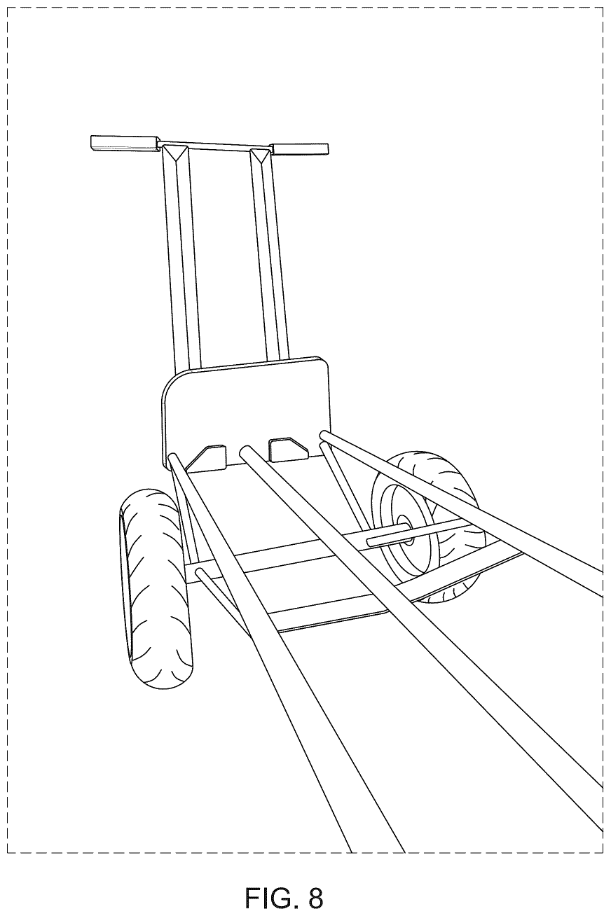

The Dolly Tool is designed as a removable component that securely attaches to the base of a dolly via two brackets fuse to the two vertical support beams at the base of the beams, as illustrated in FIG. 8 through FIG. 10, to assist with lifting a loaded dolly,

### SUMMARY

The Dolly Tool may be created from various metals, and produced in different sizes, and densities for optimal use in residential and commercial settings.

The Dolly Tool is strategically designed to attach to the base of the dolly's horizontal nose with two mounting mechanisms for securely attaching the assist tool to the dolly's horizontal nose.

The Dolly Tool is designed to provide for easy install, by attaching to the base of the dolly's horizontal nose and install assist tool compatible with various dolly designs.

The Dolly Tool is an invention that enhances the maneuverability of traditional dollies.

The unique design of The Dolly Tool reduces physical strain associated with lifting heavy loads using a dolly.

The t-shaped design of The Dolly Tool improves efficiency in material handling operations with various dolly designs.

The Dolly Tool provides a tool that assists in lifting and maneuvering a loaded dolly.

1. A dolly lifting assist tool comprised of a t-shaped tool designed to attach to the base of the dolly's horizontal nose with lifting handles ergonomically positioned and a unique hook located at the base of the device for securely attaching The Dolly Tool to the dolly frame.

2. The dolly lifting assist tool of claim 1, wherein the support frame is constructed from a durable, dense material, including but not limited to carbon steel, stainless steel, aluminum alloys, adamantium, vibranium, titanium and titanium alloys, nickel and nickel alloys. Cobalt, tungsten carbide, molybdenum alloys, copper and copper alloys, and vanadium alloys.

3. The dolly lifting assist tool of claim 1, wherein The Dolly Tool is easily detachable and transferable between different dollies, with its unique hook edge created for universal fit to ensure compatibility with a wide range of dolly sizes and designs.

4. The dolly lifting assist tool of claim 1, wherein the t-shape support structure of the device with proportional handles connected by a horizontal center beam separating the right and left handles with an equal distance apart in length, connected by the center beam fused or welded to two support beams creating the body of the device, proceeding to the base of the device which is comprised of a rear horizontal support beam fused or welded to the two main vertical support beams, leading to two base brackets at the base of the device with each respective bracket fused or welded to the individual main beams of the device with a horizontal top provides a stability and prevents flexing under heavy loads.

5. The dolly lifting assist tool of claim 1, wherein the entire assembly is designed to be compact for convenient storage and transport when not in use.

6. The dolly lifting assist tool of claim 1, wherein The Dolly Tool is made from heavy duty materials coated to ensure durability and longevity in various working conditions, including outdoor and wet environments.
